(19) United States
(12) Patent Application Publication
(10) Pub. No.: US 2024/0097459 A1
(43) Pub. Date: Mar. 21, 2024

(54) ELECTRICAL CIRCUIT FOR A HIGH-VOLTAGE NETWORK OF A VEHICLE

(71) Applicants: Robert Bosch GmbH, Stuttgart (DE); Dr. Ing. h.c. F. Porsche AG, Stuttgart (DE)

(72) Inventors: Johannes SWOBODA, Stuttgart (DE); Samuel Vasconcelos ARAUJO, Esslingen am Necker (DE); Ian Patrick MOSS, Stuttgart (DE); Tim BURRER, Pforzheim (DE); Marc PATT, Steinheim (DE); Eike EPLER, Stuttgart (DE)

(21) Appl. No.: 18/470,843

(22) Filed: Sep. 20, 2023

(30) Foreign Application Priority Data
Sep. 21, 2022 (DE) 102022124285.4

(51) Int. Cl. H02J 7/00; B60L 50/60; B60L 53/16

(52) U.S. Cl. CPC H02J 7/0024; B60L 50/66; B60L 53/16; H02J 7/0031

(57) ABSTRACT

An electrical circuit for a vehicle high-voltage network, the network including two electrical stores. The circuit includes first and second connection points for electrical connection to a load and/or charging device, a first switch between a first pole connector, for electrical contacting a first pole of a first electrical store, and the first connection point, a second switch between a second pole connector, for electrical contacting a second pole of a second electrical store, and the second connection point, a third switch between the first pole connector and a third pole connector, for electrical contacting a first pole of the second electrical store, and a fourth switch between the second pole connector and a fourth pole connector, for electrical contacting a second pole of the first electrical store. The switches are switchable between connecting and separating states. The first and/or second switches galvanically separate in the separating state.

This application claims priority to German Patent Application 102022124285.4 filed Sep. 21, 2022, the entirety of which is incorporated by reference herein.

### PRIOR ART

The present invention relates to an electrical circuit for a high-voltage network of a vehicle. In this case, the high-voltage network can comprise an electrical energy store and power electronics, for example a traction machine and an inverter. The electrical circuit allows for separation and completion of an electrical connection between the electrical energy stores and the remainder of the high-voltage network.

Current high-voltage networks for electric vehicles comprise one or more energy stores, at least one traction machine, a charging connection, one or more secondary loads such as coolant compressors or flow heaters, and one or more inverters. If the electric vehicle comprises an energy store, then this is connected to the remainder of the high-voltage network via two switching units. If the electric vehicle comprises a plurality of energy stores, a more complex connection of the electrical energy stores to the high-voltage network is required. Hitherto, said electrical connection between the electrical energy stores and the remainder of the high-voltage network has been implemented by high-voltage relays. Said high-voltage relays allow for galvanic separation of the electrical energy stores from the remainder of the high-voltage network and were therefore used for safety reasons.

EP 2 469 572 A1 discloses an electricity storage system that comprises a storage device, a charging and discharging switching device connected to the storage device, a control block which is a charging and discharging control device which controls the charging from an energy supply and the discharging from the storage device to an external load, and a disconnector having transmit and receive functions, which is provided between the storage device and the charging and discharging switching device. The disconnector serves to separate the connection to the storage device upon detection of an anomaly of the storage device or when instructed by the control block, and to inform the control block of the completed separation. The control block (80) comprises a hardware separation instruction unit and a software separation instruction unit.

WO 2017/074480 A1 describes systems and methods for separating a battery. The systems and methods can be used for separating a battery from a DC bus of a vehicle when the DC bus is under load. The system comprises one or more electrical contactors between the battery bank and the DC bus, and furthermore a controller. The controller is configured to reduce a current limit of a drive train of the vehicle to a first current level. The controller is also configured to open the one electrical contactor or the plurality of electrical contactors. The controller is furthermore configured to increase the current limit of the drive train of the vehicle to a second current level.

WO 2012/117113 A1 discloses an electrical energy supply and/or storage device comprising a plurality of electrical energy supply housings arranged in series. The energy supply and/or storage device comprises a frame which is provided with receiving points for receiving the energy supply housing in a removable manner, wherein the receiving points comprise electrical contacts for electrically connecting an energy supply housing to the connections of the electrical energy supply and/or storage device, by means of an energy bus. Each receiving point is provided with a frame switch in such a way that, in the event of a particular energy supply housing failing, at one receiving point, an electrical energy supply can be maintained by means of at least one other energy supply housing provided at another point of the frame.

### DISCLOSURE OF THE INVENTION

An electrical circuit according to the invention for a high-voltage network of a vehicle comprises at least two connection points and four switching units, wherein the high-voltage network comprises at least two electrical energy stores. A first connection point and a second connection point are configured to form an electrical connection to a first electrical load and/or an electrical charging device.

A first switching unit is arranged between a first pole connector and the first connection point. The first pole connector is configured for electrically contacting a first pole of an electrical energy store. A second switching unit is arranged between a second pole connector and the second connection point. The second pole connector is configured for electrically contacting a second pole of a second electrical energy store.

A third switching unit is arranged between the first pole connector and a third pole connector. The third pole connector is configured for electrically contacting a first pole of the second electrical energy store. A fourth switching unit is arranged between the second pole connector and a fourth pole connector. The fourth pole connector is configured for electrically contacting a second pole of the first electrical energy store.

The four switching units can be switched between an electrically connecting and an electrically separating state. As a result, the first energy store and the second energy store can be connected in parallel and in series with one another. By closing all four switching units, in each case the like poles of the first energy store and of the second energy store are electrically connected to a connection point, and the first energy store and the second energy store are connected in parallel with one another. Opening the fourth switching unit breaks the circuit of the first electrical energy store, and thus also the parallel connection of the first electrical energy store to the second electrical energy store. Opening the third switching unit breaks the circuit of the second electrical energy store, and thus also the parallel connection of the second electrical energy store to the first electrical energy store. The two electrical energy stores can be separated from the connection points by the first switching unit and the second switching unit.

This arrangement of the switching units makes it possible for either the first electrical energy store or the second electrical energy store to be electrically connected to the high-voltage network. Likewise, the two electrical energy stores can be electrically connected, in parallel with one another, to the high-voltage network. Furthermore, the first switching unit and/or the second switching unit are configured such that the first switching unit and/or the second switching unit are also galvanically separating, in an electrically separating state. The third switching unit and the fourth switching unit are preferably configured as semiconductor components.

Thus, the first electrical energy store and the second electrical energy store are in each case connected to the high-voltage network via a switching unit which is configured as a semiconductor component, and via a switching unit which is configured to be galvanically separating in the electrically separating state. A galvanic separation of the circuit of the first electrical energy store and of the second electrical energy store can be performed by means of the first switching unit and the second switching unit. As a result, the advantages of the high-voltage relay can be transferred to this electrical circuit. Semiconductor components are significantly more dynamic in their switching behavior, have a longer service life, can be produced smaller than a high-voltage relay, and can be adjusted to higher voltages in a simpler and more cost-effective manner.

Designing the third switching unit and the fourth switching unit as semiconductor components makes it possible for the electrical connection of the first pole of the second energy store and the electrical connection of the second pole of the first energy store to be broken significantly more quickly than in the case of a high-voltage relay. As a result, short-circuit currents can be broken more quickly than in the case of a high-voltage relay.

The arrangement described hitherto of the four switching units makes it possible for the first switching unit and the second switching unit to be opened, in an idle state of the vehicle in which no current flows into or out of the first energy store and/or the second energy store. The galvanic separation results in a drop in all the voltage difference between the like poles of the first energy store and of the second energy store, at the first switching unit and the second switching unit, and in said difference no longer being present at the semiconductor components of the third switching unit and the fourth switching unit. As a result, a loading of the third switching unit and of the fourth switching unit in an idle state of the vehicle is reduced, and thus the service life of the semiconductor components is extended.

Preferred developments of the invention are specified in the dependent claims.

The third switching unit and the fourth switching unit of the electrical circuit preferably comprise one or more transistors. In contrast with simple diodes, transistors make it possible, by means of a control voltage, to allow a current flow even against the blocking direction thereof. As a result, a transistor can allow a current flow in both directions, which would not be possible with a simple diode.

Particularly preferably, the third switching unit and the fourth switching unit of the electrical circuit each comprise two transistors, which are in each case arranged in such a way that their blocking directions are opposing. Thus, first, always one of the two transistors of the third switching unit and/or of the fourth switching unit blocks a charging current or a discharge current of the first electrical energy store and/or of the second electrical energy store. Only by switching of the transistor operated counter to its blocking direction into an electrically connecting state can a charging current or discharge current flow, and thus the first electrical energy store and/or the second electrical energy store be charged or discharged. In particular, the transistors of the third switching unit and the fourth switching unit are interconnected via their source side or their drain side.

The electrical circuit preferably comprises at least one fifth switching unit, which is arranged between the third pole connector and the fourth pole connector. In particular, the fifth switching unit can be switched between an electrically separating and electrically connecting state and is configured as a semiconductor component. The fifth switching unit allows for an electrical connection between the second pole of the first electrical energy store and the first pole of the second electrical energy store. If the fifth switching unit is in an electrically connecting state, the first electrical energy store and the second electrical energy store are connected in series. Designing the fifth switching unit as a semiconductor component makes it possible for the electrical connection between the first electrical energy store and the second electrical energy store to be broken more quickly than in the case of a high-voltage relay. As a result, the fifth switching unit can also prevent short-circuit currents during operation of the first electrical energy store and the second electrical energy store in a series connection. Due to the smaller design of the semiconductor components, more complex circuits, which are required for changing between a series and parallel connection of the first electrical energy store to the second electrical energy store, can be implemented with a smaller increase in installation space than in the case of a high-voltage relay. Such a connection allows both for powers at the electrical load with lower losses than would be the case for a parallel connection of the two electrical energy stores, and for the first electrical energy store and the second electrical energy store to be charged using charging sources which have lower charging voltages than the overall voltage of the two series-connected electrical energy stores. Preferably, the fifth switching unit comprises one or more transistors.

Particularly preferably, the fifth switching unit of the electrical circuit comprises two transistors, which are in each case arranged in such a way that their blocking directions are opposing. As a result, both a charging current and a discharge current always flow counter to the blocking direction of one of the two transistors of the fifth switching unit. Only by switching the transistor, against the blocking direction of which a current is intended to flow, into an electrically connecting state, can a charging current or discharge current flow, and the first electrical energy store and the second electrical energy store be charged or discharged in a series connection. In particular, the transistors of the fifth switching unit are interconnected via their source side or their drain side.

The electrical circuit preferably comprises a charging connection for connection to a charging unit for charging the first electrical energy store and the second electrical energy store. In addition, the electrical circuit comprises a sixth switching unit and a seventh switching unit. The sixth switching unit is arranged between the charging connection and the first connection point. The seventh switching unit is arranged between the charging connection and the second connection point. The sixth switching unit and the seventh switching unit can be switched between an electrically separating and an electrically connecting state. As a result, an external charging unit can be connected to the charging connection, and an electrical connection to the first connection point and to the second connection point can be established via the sixth switching unit and the seventh switching unit. If the first switching unit, the second switching unit, the sixth switching unit and the seventh switching unit are in an electrically connecting state, an electrical connection exists between the charging device and the first electrical energy store and the second electrical energy store. If, in addition, the third switching unit and the fourth switching unit are in an electrically connecting state and the fifth switching unit is in an electrically separating state, the first electrical energy store and the second electrical energy store are connected to the charging unit in parallel. If, instead, the third switching unit and the fourth switching unit are in an electrically separating state and the fifth switching unit is in an electrically connecting state, the first electrical energy store and the second electrical energy store are connected to the charging unit in series. This is advantageous in particular in order to adjust the overall voltage of the first electrical energy store and of the second electrical energy store to the charging voltage of different charging units. Thus, a parallel connection of the first electrical energy store and the second electrical energy store to the charging unit can be used for charging the two electrical energy stores, the charging voltage of which is not below a voltage of one of the two electrical energy stores. By means of a series connection of the first electrical energy store and the second electrical energy store, charging units having higher charging voltages can be used for charging the first electrical energy store and the second electrical energy store.

The invention furthermore relates to a high-voltage network of a vehicle, comprising a first battery and a second battery as a first electrical energy store and a second electrical energy store. The first battery and the second battery each have two opposite poles. In this case, the first pole of the first battery is electrically connected to the first pole connector, and the second pole of the first battery is electrically connected to the fourth pole connector. The first pole of the second battery is electrically connected to the third pole connector, and the second pole of the second battery is electrically connected to the second pole connector.

The invention furthermore relates to a vehicle comprising a high-voltage network, an electrical circuit, and at least one electrical load. In particular, the electrical load is an electric vehicle drive which has two opposite poles. In this case, the first pole of the electric vehicle drive is electrically connected to the first connection point, and a second pole of the electric vehicle drive is electrically connected to the second connection point.

### BRIEF DESCRIPTION OF THE DRAWINGS

Embodiments of the invention will be described in detail in the following, with reference to the accompanying drawings, in which:

FIG. 1 is a schematic view of a vehicle comprising a high-voltage network and an electrical circuit according to one embodiment of the invention, and

FIG. 2 is a schematic view of the electrical circuit according to the embodiment, with a high-voltage network and a charging unit.

### EMBODIMENTS OF THE INVENTION

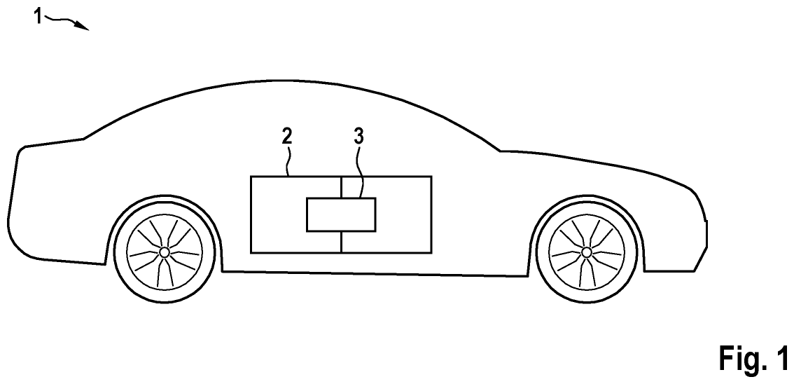

FIG. 1 schematically shows a vehicle 1 which comprises a high-voltage network 2 and an electrical circuit 3 according to one embodiment of the invention. In this case, the high-voltage network 2 and the electrical circuit 3 are electrically interconnected.

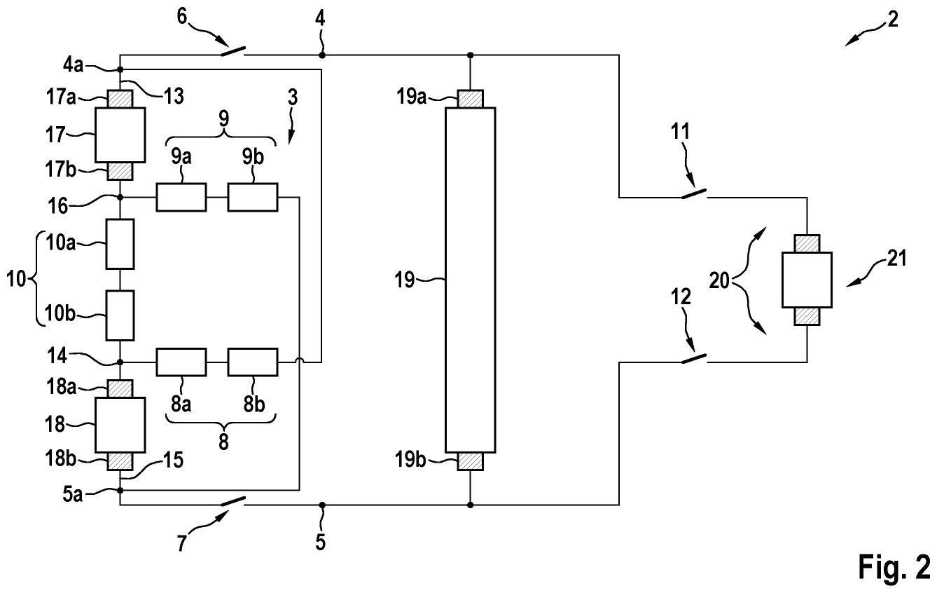

FIG. 2 schematically shows a high-voltage network 2 and the electrical circuit 3 according to the embodiment of the invention, which is electrically connected to the high-voltage network 2. The high-voltage network 2 comprises a first battery 17 as a first electrical energy store comprising a first pole 17a and a second pole 17b, and a second battery 18 as a second electrical energy store comprising a first pole 18a and a second pole 18b. The poles 17a, 17b, 18a, 18b of the first battery 17 and of the second battery 18 are opposite.

A first connection point 4 is configured for electrically contacting a first pole 19a of an electrical load 19, which is in particular a vehicle drive, or an electrical charging device 21, in particular a DC charging device. A second connection point 5 is configured for electrically contacting a second pole 19b of an electrical load 19 or an electrical charging device 21.

A first switching unit 6 is electrically connected to a first pole connector 13 and the first connection point 4. The first pole connector 13 is electrically connected to the first pole 17a of the first battery 17. A second switching unit 7 is electrically connected to a second pole connector 15 and the second connection point 5. The second pole connector 15 is electrically connected to the second pole 18b of the second battery 18. The first switching unit 6 and the second switching unit 7 can be switched between an electrically separating and an electrically connecting state. In particular, the first switching unit 6 and the second switching unit 7 are configured so as to be galvanically separating in an electrically separating state. This allows for a reliable separation between the first battery 17 and the second battery 18 and further electrical loads 19 or electrical charging devices 21 connected to the first connection point 4 and the second connection point 5.

A third switching unit 8 is electrically connected to a third pole connector 14 and the first pole connector 13. The third pole connector 14 is configured for electrically contacting the first pole 18a of the second battery 18. A fourth switching unit 9 is electrically connected to a fourth pole connector 16 and the second pole connector 15.

The fourth pole connector 16 is configured for electrically contacting the second pole 17a of the first battery 17. A fifth switching unit 10 is electrically connected to the third pole connector 14 and the fourth pole connector 16. The third switching unit 8, the fourth switching unit 9 and the fifth switching unit 10 are configured in each case as two transistors 8a, 8b, 9a, 9b, 10a, 10b that are arranged counter to their blocking directions, and can be switched between an electrically connecting and an electrically separating state.

The first switching unit 6, the first pole connector 13 and the third switching unit 8 are thus interconnected at a first contact point 4a. Likewise, the second switching unit 7, the second pole connector 15 and the fourth switching unit 9 are interconnected at a second contact point 5b. The first switching unit 6 is thus provided between the first contact point 4a and the first connection point 4. The second switching unit 7 is in particular provided between the second contact point 5a and the second connection point 5.

Transistors can be configured so as to be significantly smaller compared with high-voltage relays, and therefore require less space in the electrical circuit. Furthermore, transistors do not comprise any mechanical components which have to be moved from an electrically connecting into an electrically separating state, for switching, and therefore have significantly greater switching dynamics than a high-voltage relay. This is particularly important if occurring short-circuits or overvoltages at the first battery 17 and the second battery 18 are intended to be prevented, in order to prevent damage to the first battery 17 and the second battery 18. For this purpose, the circuit can be broken by switching the transistors 8a, 8b, 9a, 9b, 10a, 10b of the third switching unit 8, the fourth switching unit 9 and the fifth switching unit 10 into an electrically separating state. Since the transistors 8a, 8b, 9a, 9b, 10a, 10b of the third switching unit 8, the fourth switching unit 9 and the fifth switching unit 10 are arranged counter to their blocking directions, in each case one of the two transistors of one of the switching units 8, 9, 10 blocks a current in its flow direction. Thus, the switching units 8, 9, 10 can break both a charging current and a discharge current. Only by switching the transistor, against the blocking direction of which a current is intended to flow, into an electrically connecting state, can a current flow.

If the first switching unit 6 and the second switching unit 7 are in an electrically connecting state, a parallel connection of the first battery 17 to the second battery 18 takes place, in that the third switching unit 8 and the fourth switching unit 9 are in an electrically connecting state, and the fifth switching unit 10 is in an electrically separating state. By switching the third switching unit 8 and the fourth switching unit 9 into an electrically separating state, and the fifth switching unit 10 into an electrically connecting state, the first battery 17 and the second battery 18 can be connected in series.

As shown in FIG. 2, the high-voltage network 2 comprises an electrical load 19 having two opposite poles 19a, 19b. In this case, the first pole 19a of the electrical load 19 is electrically connected to the first connection point 4, and the second pole 5 of the electrical load 19 is electrically connected to the second connection point 5. If the first switching unit 6 and the second switching unit 7 are in an electrically connecting state, the electrical load 19 is electrically connected to the first battery 17 and to the second battery 18 and can be supplied with power thereby. In particular, the first battery 17 and the second battery 18 can be interconnected in series when the first electrical load 19 is supplied, in order to output higher power to the electrical loads 19 at reduced losses.

A charging device 21 for charging the first battery 17 and the second battery 18 can be connected via a charging connection 20. The charging connection 20 can be electrically connected to the first connection point 4 via a sixth switching unit 11, and to the second connection point 5 via a seventh switching unit 12. The sixth switching unit 11 and the seventh switching unit 12 can be switched between an electrically separating and an electrically connecting state. In particular, the sixth switching unit 11 and the seventh switching unit 12 are configured so as to be galvanically separating in an electrically separating state.

If the first switching unit 6, the second switching unit 7, the sixth switching unit 11 and the seventh switching unit 12 are in an electrically connecting state, an electrical connection exists between the charging device 21 and the first battery 17 and the second battery 18. The first battery 17 and the second battery 18 can be charged by the charging device 21 both in a series connection and in a parallel connection. The connection of the first battery 17 to the second battery 18 can be adjusted to the charging voltage provided by the charging device 21. Thus, the overall voltage of the first battery 17 and of the second battery 18 is higher in a series connection than in a parallel connection.

1. An electrical circuit for a high-voltage network of a vehicle, wherein the high-voltage network comprises at least two electrical energy stores, the electrical circuit comprising:
at least one first connection point and one second connection point which are configured for electrical connection to a load and/or a charging device,
at least one first switching unit which is arranged between a first pole connector, configured for electrical contacting of a first pole of a first electrical energy store, and the first connection point,
at least one second switching unit which is arranged between a second pole connector, configured for electrical contacting of a second pole of a second electrical energy store, and the second connection point,
at least one third switching unit which is arranged between the first pole connector and a third pole connector, configured for electrical contacting of a first pole of the second electrical energy store, and
at least one fourth switching unit which is arranged between the second pole connector and a fourth pole connector, configured for electrical contacting of a second pole of the first electrical energy store,
wherein the switching units (8, 9) can be switched between an electrically connecting and an electrically separating state,
wherein the first switching unit and/or the second switching unit are configured so as to be electrically separating in the electrically separating state, and
wherein the third switching unit and/or the fourth switching unit are configured as semiconductor components.

2. The electrical circuit according to claim 1, wherein the third switching unit and/or the fourth switching unit comprise one or more transistors.

3. The electrical circuit according to claim 2, wherein the third switching unit and/or the fourth switching unit each comprise two transistors, which are in each case arranged in such a way that the blocking directions thereof are opposing, wherein preferably the transistors of the third switching unit and/or of the fourth switching unit are in each case electrically interconnected via their source side.

4. The electrical circuit according to claim 1, characterized by at least one fifth switching unit which is arranged between the third pole connector and the fourth pole connector, wherein preferably the fifth switching unit is configured as a semiconductor component and can be switched between an electrically connecting and an electrically separating state.

5. The electrical circuit according to claim 4, wherein the fifth switching unit comprises two transistors, which are in each case arranged in such a way that the blocking directions thereof are opposing, wherein preferably the transistors of the fifth switching unit are preferably electrically interconnected via their source side.

6. The electrical circuit according to claim 1, characterized by a charging connection for connection to a charging unit for charging the electrical energy stores, the electrical circuit comprising:
at least one sixth switching unit which is arranged between the charging connection and the first connection point, and at least one seventh switching unit which is arranged between the charging connection and the second connection point,
wherein the sixth switching unit and/or the seventh switching unit can be switched between an electrically connecting and an electrically separating state.

7. A high-voltage network of a vehicle comprising an electrical circuit according to claim 1, a first battery having two opposite poles as a first electrical energy store, and a second battery having two opposite poles as a second electrical energy store, wherein the first pole of the first battery is electrically connected to the first pole connector, and the second pole of the first battery is electrically connected to the fourth pole connector, and the first pole of the second battery is electrically connected to the third pole connector, and the second pole of the second battery is electrically connected to the second pole connector.

8. A vehicle comprising an electrical circuit according to claim 1, and at least one electrical load, in particular an electrical vehicle drive, which comprises two opposite poles, wherein a first pole of an electrical vehicle drive is electrically connected to the first connection point, and a second pole of an electrical vehicle drive is electrically connected to the second connection point.
